(19) United States
(12) Patent Application Publication
(10) Pub. No.: US 2014/0366541 A1
(43) Pub. Date: Dec. 18, 2014

(54) SYSTEMS AND APPARATUS RELATING TO FUEL INJECTION IN GAS TURBINES

(71) Applicant: General Electric Company, Schenectady, NY (US)

(72) Inventors: Gregory Earl Jensen, Greenville, SC (US); Bryan Wesley Romig, Simpsonville, SC (US); Jason Thurman Stewart, Greer, SC (US); Jason Charles Terry, Greenville, SC (US)

(21) Appl. No.: 13/917,964

(22) Filed: Jun. 14, 2013

(51) Int. Cl. F02C 7/22

(52) U.S. Cl. CPC F02C 7/22
USPC 60/734

(57) ABSTRACT

A gas turbine engine having a combustor that includes: an inner radial wall defining a first interior chamber and a second interior chamber, wherein the first interior chamber extends axially from an end cover to a primary fuel injector, and the second interior chamber extends axially from the primary fuel injector to the turbine; an outer radial wall formed about the inner radial wall so that a flow annulus is formed therebetween; upstream fuel nozzles jutting into the flow annulus from the outer radial wall. The upstream fuel nozzles may include non-uniform circumferential spacing about the inner radial wall.

### BACKGROUND OF THE INVENTION

This present application relates generally to the combustion systems in combustion or gas turbine engines (hereinafter “gas turbines”). More specifically, but not by way of limitation, the present application describes novel methods, systems, and/or apparatus related to the injection of fuel upstream of the primary fuel injectors in gas turbine combustors.

The efficiency of gas turbines has improved significantly over the past several decades as new technologies enable increases to engine size and higher operating temperatures. One technical basis that allowed these higher temperatures was the introduction of new and innovative heat transfer technology for cooling components within the hot gas path. Additionally, new materials have enabled higher temperature capabilities within the combustor.

During the same time frame, however, new standards were enacted that limit the levels at which certain pollutants may be emitted during operation. Specifically, the emission levels of NOx, CO and UHC, all of which are sensitive to the operating temperature of the engine, were more strictly regulated. Of those, the emission level of NOx is especially sensitive to increased emission levels at higher firing temperatures and, thus, became a significant limit as to how much temperatures can be increased. Because higher operating temperatures coincide with more efficient engines, this hindered advances in engine efficiency. In short, combustor operation became a significant limit on gas turbine operating efficiency.

As a result, one of the primary goals of combustor design technologies became developing ways to reduce combustor driven emission levels so that higher firing temperatures and enhanced engine efficiencies could be realized. One important technology advancement involved the injection of fuel upstream of the combustor's primary fuel injector, which was shown to increase fuel/air mixing, combustion characteristics, and reduce NOx emissions. However, it was found that, given the conventional arrangement of upstream fuel injection systems, fuel injection into this region significantly increased the occurrences of unintended combustion (i.e., auto-ignition or flame-holding) upstream of the primary fuel injector, which, as one of ordinary skill in art will appreciate, typically results in damaged combustor components and increased operating costs. Accordingly, as will be appreciated, novel combustion system designs that enable higher firing temperatures and improved emission levels, while also mitigating the risk of unintended combustion, would be demanded commercially.

### BRIEF DESCRIPTION OF THE INVENTION

The present application thus describes a gas turbine engine having a combustor that includes an inner radial wall defining a first interior chamber and a second interior chamber. The first interior chamber may extend axially from an end cover to a primary fuel injector, and the second interior chamber extends axially from the primary fuel injector to the turbine. An outer radial wall may be formed about the inner radial wall so that a flow annulus is formed therebetween, and upstream fuel nozzles may jut into the flow annulus from the outer radial wall. The upstream fuel nozzles may include non-uniform circumferential spacing about the inner radial wall.

The present application further describes an upstream fuel injection system for use in a gas turbine engine having a combustor that includes: an inner radial wall defining a first interior chamber and a second interior chamber, wherein the first interior chamber extends axially from an end cover to a primary fuel injector, and the second interior chamber extends axially from the primary fuel injector to the turbine. An outer radial wall may be formed about the inner radial wall so that a flow annulus is formed therebetween. The primary fuel injector may include a center fuel nozzle and a plurality of periphery fuel nozzles are spaced about a circumference of the center fuel nozzle. The upstream fuel injection system may include upstream fuel nozzles jutting into the flow annulus from the outer radial wall. The upstream fuel nozzles may be circumferentially spaced about the inner radial wall so to form a circumferential cluster that corresponds to the angular positioning of each of the plurality of periphery fuel nozzles.

These and other features of the present application will become more apparent upon review of the following detailed description of the preferred embodiments when taken in conjunction with the drawings and the appended claims.

### BRIEF DESCRIPTION OF THE DRAWINGS

The invention of the present application will be more completely understood and appreciated by careful study of the following more detailed description of exemplary embodiments taken in conjunction with the accompanying drawings, in which:

FIG. 1 is a sectional schematic representation of an exemplary gas turbine in which certain embodiments of the present application may be used;

FIG. 2 is an axial cross-sectional view of a conventional combustor in which embodiments of the present invention may be used;

FIG. 3 is an axial cross-sectional view of a conventional combustor according to aspects of the present invention;

FIG. 4 is an axial cross sectional view of a combustor according to aspects of the present invention;

FIG. 5 is a radial cross-sectional view of a combustor according to aspects of the present invention;

FIG. 6 is a radial cross-sectional view of a combustor according to aspects of the present invention;

FIG. 7 is a side cross-sectional view of an upstream fuel nozzle according to aspects of the present invention; and

FIG. 8 is a cross-sectional view taken along 8-8 of FIG. 7.

### DETAILED DESCRIPTION OF THE INVENTION

The following description provides examples of both conventional technology and the present invention, as well as, in the case of the present invention, several exemplary implementations and explanatory embodiments. However, it will be appreciated that the following examples are not intended to be exhaustive as to all possible applications the invention. Further, while the following examples are presented in relation to a certain type of turbine engine, the technology of the present invention also may be applicable to other types of turbine engines as would the understood by a person of ordinary skill in the relevant technological arts.

In the following text, certain terms have been selected to describe the present invention. To the extent possible, these terms have been chosen based on the terminology common to the field. Still, it will be appreciate that such terms often are subject to differing interpretations. For example, what may be referred to herein as a single component, may be referenced elsewhere as consisting of multiple components, or, what may be referenced herein as including multiple components, may be referred to elsewhere as being a single component. In understanding the scope of the present invention, attention should not only be paid to the particular terminology used, but also to the accompanying description and context, as well as the structure, configuration, function, and/or usage of the component being referenced and described, including the manner in which the term relates to the several figures, as well as, of course, the precise usage of the terminology in the appended claims.

Because several descriptive terms are regularly used in describing the components and systems within turbine engines, it should prove beneficial to define these terms at the onset of this section. Accordingly, these terms and their definitions, unless specifically stated otherwise, are as follows. The terms “forward” and “aft”, without further specificity, refer to directions relative to the orientation of the gas turbine. That is, “forward” refers to the forward or compressor end of the engine, and “aft” refers to the aft or turbine end of the engine. It will be appreciated that each of these terms may be used to indicate movement or relative position within the engine. The terms “downstream” and “upstream” are used to indicate position within a specified conduit relative to the general direction of flow moving through it. The term “downstream” refers to the direction in which the fluid is flowing through the specified conduit, while “upstream” refers to the direction opposite that.

Thus, for example, the primary flow of fluid through a turbine engine, which consists of air through the compressor and then becomes the combustion gases within the combustor, may be described as beginning from an upstream location at an upstream end of the compressor and terminating at an downstream location at a downstream end of the turbine. In regard to describing the direction of flow within a common type of combustor, as discussed in more detail below, it will be appreciated that compressor discharge air typically enters the combustor through impingement ports that are concentrated toward the aft end of the combustor (relative to the combustors longitudinal axis and the aforementioned compressor/turbine positioning defining forward/aft distinctions). Once in the combustor, the compressed air is guided by a flow annulus formed about an interior chamber toward the forward end of the combustor, where the air flow enters the interior chamber and, reversing it direction of flow, travels toward the aft end of the combustor. Coolant flows through cooling passages may be treated in the same manner.

Given the configuration of compressor and turbine about a central common axis as well as the cylindrical configuration common to certain combustor types, terms describing position relative to an axis will be used. In this regard, it will be appreciated that the term “radial” refers to movement or position perpendicular to an axis. Related to this, it may be required to describe relative distance from the central axis. In this case, if a first component resides closer to the central axis than a second component, it will be described as being either “radially inward” or “inboard” of the second component. If, on the other hand, the first component resides further from the central axis than the second component, it will be described herein as being either “radially outward” or “outboard” of the second component. Additionally, it will be appreciated that the term “axial” refers to movement or position parallel to an axis. Finally, the term “circumferential” refers to movement or position around an axis. As mentioned, while these terms may be applied in relation to the common central axis that extends through the compressor and turbine sections of the engine, these terms also may be used in relation to other components or sub-systems of the engine. For example, in the case of a cylindrically shaped combustor, which is common to many machines, the axis which gives these terms relative meaning is the longitudinal central axis that extends through the center of the cross-sectional shape, which is initially cylindrical, but transitions to a more annular profile as it nears the turbine.

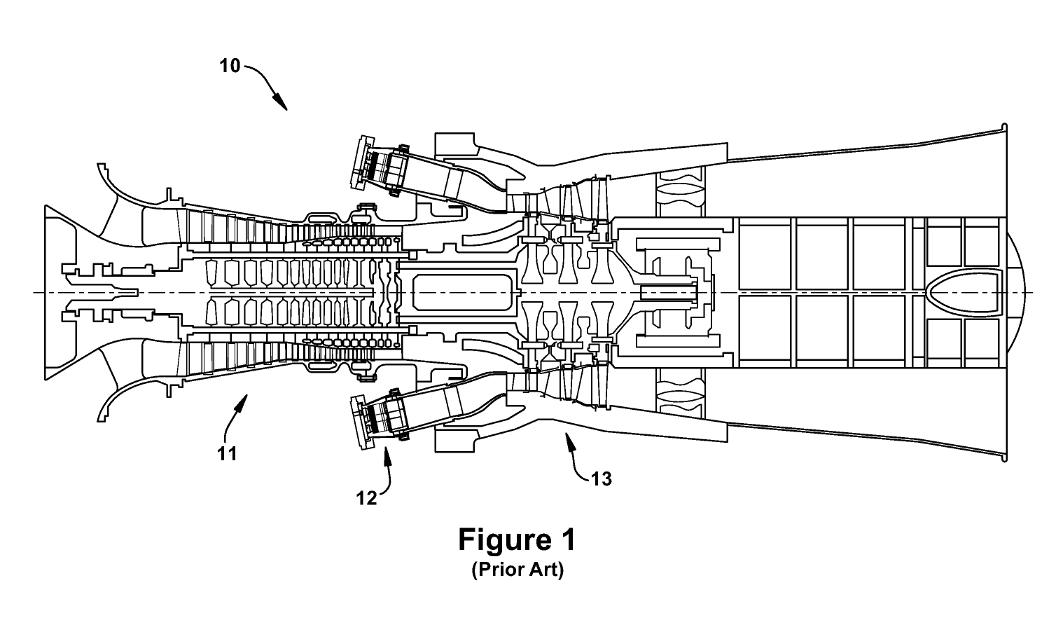

FIG. 1 is a partial cross-sectional view of a known gas turbine engine 10 in which embodiments of the present invention may be used. As shown, the gas turbine engine 10 generally includes a compressor 11, one or more combustors 12, and a turbine 13. It will be appreciated that a flowpath is defined through the gas turbine 10. During normal operation, air may enter the gas turbine 10 through an intake section, and then fed to the compressor 11. The multiple, axially-stacked stages of rotating blades within the compressor 11 compress the air flow so that a supply of compressed air is produced. The compressed air then enters the combustor 12 and directed through a primary fuel injection system or fuel injector 21, which brings together the compressed air with a fuel so to form an air-fuel mixture. The air-fuel mixture is combusted within a combustion chamber so that a high-energy flow of combustion products is created. This energetic flow of hot gases then is expanded through the turbine 13, which extracts energy from it.

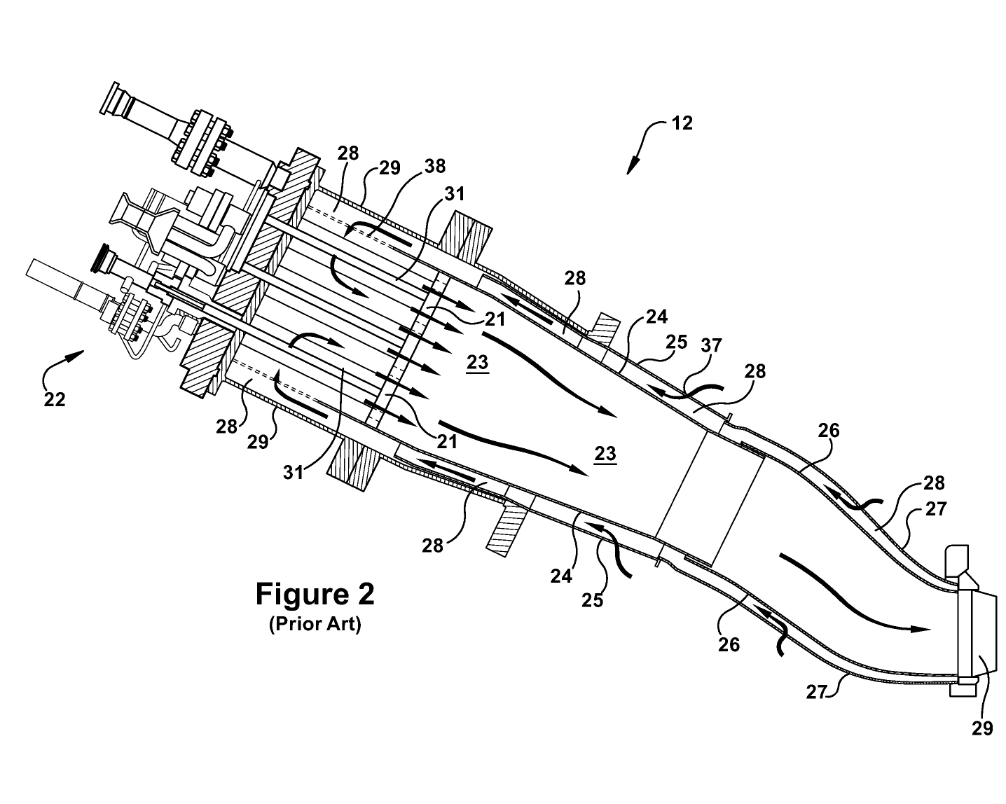

FIG. 2 illustrates an exemplary combustor 12 in which embodiments of the present invention may be used. As one of ordinary skill in the art will appreciate, at a forward end the combustor 12 includes a head end 22, which generally provides the various manifolds and apparatus that supply the necessary fuel to the primary fuel injector 21. The head end 22 may include an end cover 35 that defines a forward boundary of the interior chambers of the combustor 12. The interior chambers may include a chamber positioned within a cap assembly 31, a combustion zone 23, which is defined by a liner 24, and a transition zone, which is the downstream extension of the combustion zone that is defined by a transition piece 26. As illustrated, a plurality of fuel lines may extend through the end cover 35 to the primary fuel injector 21, which is positioned at the aft end of the cap assembly 31. The forward portion of the combustor 12 may be enclosed within a combustor casing 29.

The primary fuel injector 21 represents the main delivery and injection point of fuel within the combustor 12. It will be appreciated that the cap assembly 31 generally is cylindrical in shape and positioned immediately aft of the head end 22 and, generally, toward the forward end to the combustor 12. The cap assembly 31 may be surrounded by the combustor casing 29. It will be appreciated that the cap assembly 31 and the casing 29 may each have a cylindrical configuration and be arranged concentrically. In this arrangement, the cap assembly 31 may be described as an inner radial wall, and, positioned about the cap assembly 31, the casing 29 may be described as an outer radial wall. In this manner, the combustor casing 29 and the cap assembly 31 form an annulus between them, which is referred to herein as a combustor casing annulus or, more generally, a flow annulus 28. The cap assembly 31 also may include one or more inlets 38 that allow fluid communication between the flow annulus 28 and the interior of the cap assembly 31.

The primary fuel injector 21, as discussed more below, may include a planar array of fuel nozzles 46, 47. The primary fuel injector 21 typically is positioned at the aft end of the cap assembly 31. It will be appreciated that the combustion zone 23 occurs immediately aft of the primary fuel injector 21 and is defined by the surrounding liner 24. A typical arrangement of the multiple fuel nozzles 46, 47 includes a circular configuration about the longitudinal axis of the combustor 12. In operation, the primary fuel injector 21 brings together for combustion within the combustion zone 23 the fuel supplied via the conduit extending through the head end 22 and the air supplied via the flow annulus 28. The fuel, for example, may be natural gas. The compressed air, as indicated in FIG. 2 by the several arrows, may enter the combustor 12 via ports formed along its exterior.

As mentioned, the combustion zone 23 is defined by a surrounding liner 24. Positioned about the liner 24 is a flow sleeve 25. The flow sleeve 25 and the liner 24 also may be arranged in a concentric cylindrical configuration and, thereby, provide a continuation of the flow annulus 28 formed between the cap assembly 31 and the combustor casing 29. A transition piece 26 may connect to the liner 24 and transition the flow of combustion products aftward toward input into the turbine 13. It will be appreciated that the transition piece 26 generally transitions the flow from the circular cross-section of the liner 24 to the annular cross-section necessary for input into the turbine 13. An impingement sleeve 27 may surround the transition piece 26 so that the flow annulus 28 extends further afterward. At the downstream end of the transition piece 26, an aft frame 29 directs the flow of the combustion products toward the airfoils of the turbine 13.

The flow sleeve 25 and the impingement sleeve 27 typically have impingement apertures or ports 37 formed therethrough which allow an impinged flow of compressed air to enter the flow annulus 28. This impinged flow serves to convectively cool the exterior surfaces of the liner 24 and the transition piece 26. The compressed air then is directed via the flow annulus 28 toward the forward end of the combustor 12. Via the inlets 38 in the cap assembly 31, the compressed air enters the interior of the cap assembly 31 and is redirected via the end cover 35 toward the primary fuel injector 21. It will be appreciated that the transition piece 26/impingement sleeve 27, the liner 24/flow sleeve 25, and the cap assembly 31/combustor casing 29 pairings extend the flow annulus 28 almost the entire length of the combustor 12. As used herein, the term “flow annulus” may be used generally to refer to this entire annulus or a portion thereof.

The cap assembly 31 includes inlets 38 through which the supply of compressed air enters the interior of the cap assembly 31. The inlets 38 may be arranged parallel to each other, being spaced around the circumference of the cylindrical cap assembly 31, though other configurations are possible. In this arrangement, it will be appreciated that struts may be defined between each of the inlets 38, which support the cap assembly 31 structure during operation. It will be appreciated that the compressed air entering the combustor 12 through the flow sleeve 25 and the impingement sleeve 27 passes through the combustor casing annulus 28, which, as stated first two the annulus formed between the cap assembly 31 and the combustor casing 29. This flow of air then enters the cap assembly 31 via the inlets 38, which are formed toward the forward end of the cap assembly 31, contiguous or very near the end cover 35. Upon entering the cap assembly 31, the flow of compressed air is forced to make an approximate 180° turn so that it is delivered to the primary fuel injector 21.

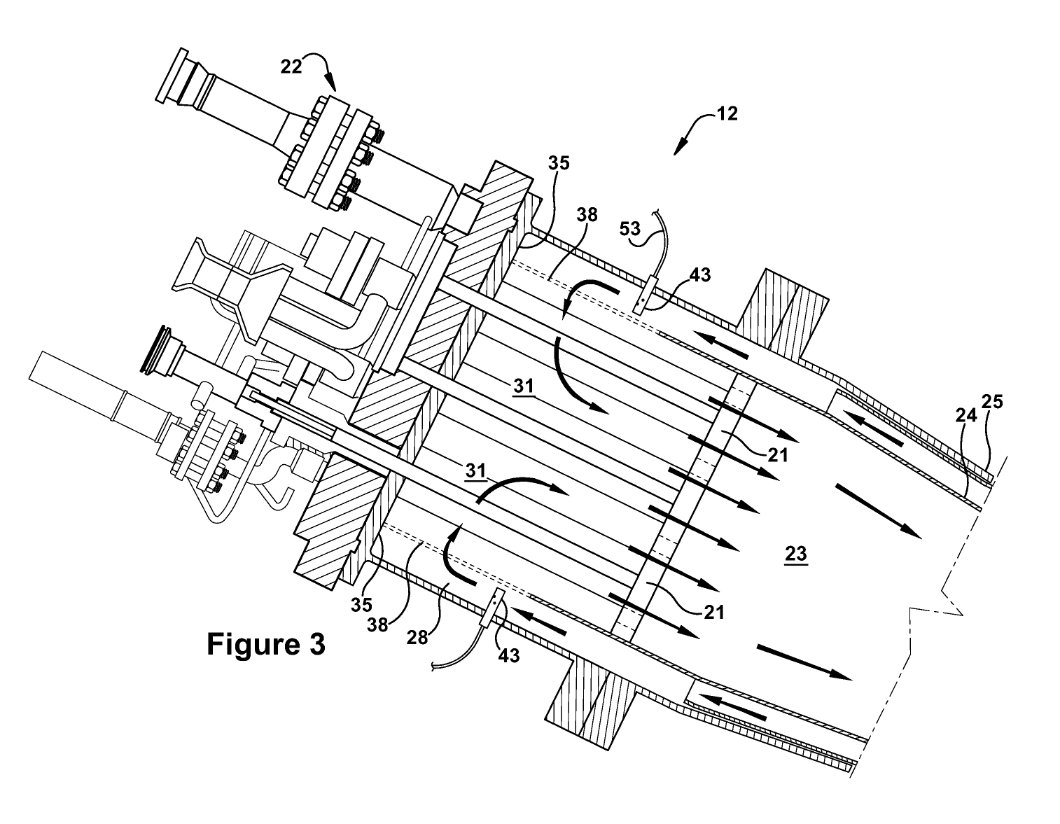

As illustrated in FIG. 3, the combustor 12 according to the present invention may include a fuel injector or nozzle that is positioned upstream of the primary fuel injector 21. As used herein, this type of fuel nozzle will be referred to as an “upstream fuel nozzle 43” and/or as part of an upstream fuel injection system 41. Unless otherwise stated, an upstream fuel nozzle 43 of the present invention may include any type fuel injector that can be used to deliver or inject fuel into the flowpath of compressed air at a location upstream of the primary fuel injector 21. According to certain embodiments described below, the upstream fuel nozzle 43 of the present invention may be defined more in more specific terms. For example, in certain instances, an upstream fuel nozzle 43 is defined as a fuel nozzle positioned within the combustor casing annulus 28, which, as stated, is the portion of the flow annulus 28 positioned about the cap assembly 31. It will be appreciated that FIG. 3 provides an example of this type of upstream fuel nozzles 43. It will be understood that the upstream fuel nozzle 43 is configured to inject a supply of fuel into the flow of compressed air moving through the flow annulus 28. It will be appreciated that this method of premixing fuel may be used to mitigate certain aspects of combustor instability, provide enhanced fuel/air mixing and, thereby, improve combustion characteristics downstream, and/or reduce certain emissions, such as NOx. However, it will also be appreciated that injecting fuel in this manner increases the risk of non-intended combustion and flame-holding in this area of the combustor 12, which often leads to damage components and undesirable operation.

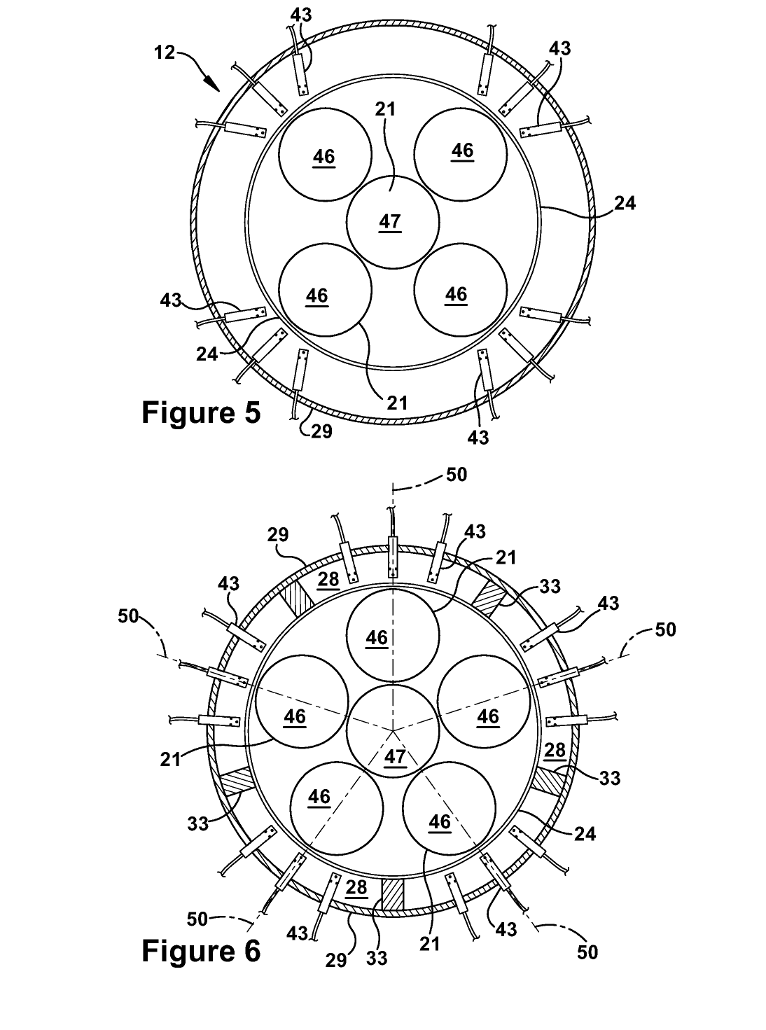

A system of upstream fuel injection according to the present invention may include a plurality of upstream fuel nozzles 43 that are circumferentially spaced in a novel manner so to improve the mixing of fuel and air, while also mitigating the risk of flameholding in this region. According to a conventional design, fuel nozzles positioned in this upstream region are circumferentially spaced at regular intervals. However, this conventional design fails to recognize the advantages that are possible from a purposeful, non-uniform or irregular circumferential spacing of upstream fuel nozzles 43. Such irregular circumferential spacing of upstream fuel nozzles 43 may configure the nozzles 43 to take into account certain uneven flow realities that occur in this region so to enhance fuel/air mixing and overall combustion characteristics within the combustion zone 23. For example, it will be appreciated that combustion is typically enhanced when the fuel injected at the upstream location is spread evenly throughout the primary fuel injector 21. However, primary fuel injectors 21 typically are made of an array of discrete fuel nozzles 46, 47. Examples of this type of arrangement are provided in FIGS. 5 and 6. As illustrated, a number of periphery fuel nozzles 46 are spaced about a center fuel nozzle 47. It will be appreciated that this results in the primary fuel injector 21 having a cross-sectional area that is not uniform, i.e., the fuel nozzles 46, 47 are separated from each other and, together, do not entirely cover the cross-sectional area of the primary fuel injector 21. As one of ordinary skill in the art will appreciate, this means that a non-regular circumferential spacing of upstream fuel nozzles 43 may be used to address this reality such that fuel injected upstream of the primary fuel injector 21 is more equally distributed among the several fuel nozzles 46, 47, particularly those fuel nozzles 46 arranged about its periphery, which, as stated, will improve the overall characteristics of the resulting combustion.

As shown in FIGS. 5 and 6, the primary fuel injector 21 may include several fuel nozzles that are arranged at the junction of the cap assembly 31 and the combustion zone 23. In a typical arrangement, the primary fuel injector includes a plurality of periphery fuel nozzles 46 circumferentially spaced about a center fuel nozzle 47. In this type of arrangement, each of the periphery fuel nozzles 46 may be described as having a reference line 50 that coincides with and describes its angular position within the interior chamber of the cap assembly 31. As illustrated in FIG. 6, one manner in which the reference line 50 may be defined is the identification of two points that define it: a first point is the center of the cap assembly 31 and the second point is the location at which the periphery fuel nozzle 46 is closest to the wall of the cap assembly 31 (or, as it is referred to herein, the “inner radial wall”, which is thusly named due to its positioning within the “outer radial wall” that, in this case, would be the combustor casing 29). As shown in FIG. 6, defined in this manner, the reference line 50 may be extended in the outboard direction to define an angular position on the combustor casing 29 or, as stated, the outer radial wall. It will be appreciated that an axially oriented reference line may extend through this angular position defined on the outer radial wall such that an angular position is defined over an axial segment of the flow annulus 28. According to embodiments of the present invention, this defined angular position within the flow annulus may be used to angularly position the upstream fuel nozzles 43 about the circumference of the inner radial wall (and relative to the angular positioning of the periphery fuel nozzles 46). As such, in one preferred embodiment, as illustrated most clearly in FIG. 6, the irregular or non-uniform circumferential spacing of the upstream fuel nozzles 43 is one that includes the upstream fuel nozzles 43 being grouped about this defined angular position on the outer radial wall (which is represented as reference line 50). According to certain embodiments of the present invention, the non-uniform circumferential spacing of the upstream fuel nozzles 43 is one in which the distance between the upstream fuel nozzles 43 within the same grouping is tighter than the distance between the groupings.

In certain embodiments, the primary fuel injector 21 may include between 4 and 6 periphery fuel nozzles 46. In such cases, for each of the periphery fuel nozzles 46, the upstream fuel injection system may include a grouping of upstream fuel nozzles 43 of between 2 and 5 fuel injectors for each of the periphery fuel nozzles 46. It will be appreciated that this sort of arrangement will result in each of the periphery fuel nozzles 46 being positioned in a path of concentrated release that each of the grouped upstream fuel injectors 43 represents, which will result in a more uniform amount of fuel being delivered across the several periphery fuel nozzles 46 of the primary fuel injector.

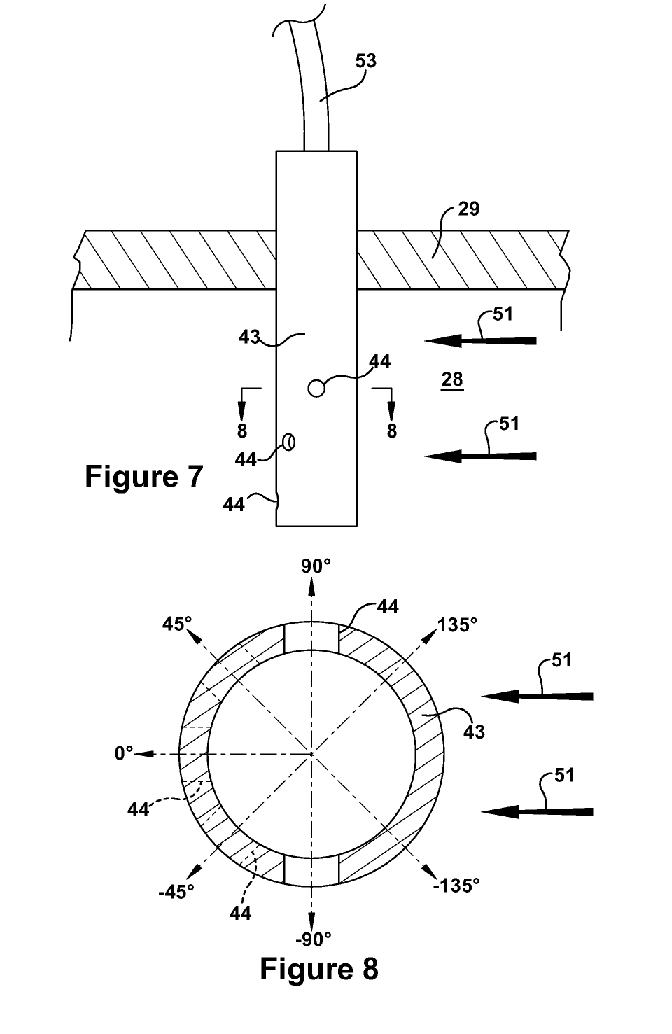

The main function of the upstream fuel nozzles 43 is to inject fuel into the flow of air upstream of the primary fuel injector 21 so that a fuel-air mixture is premixed before reaching the combustion zone 23. As illustrated in FIG. 7, the upstream fuel nozzles 43 may be configured to deliver fuel from a fuel supply 53 to fuel outlets 44 positioned within the flow annulus 28. According to embodiments of the present invention, as illustrated, the upstream fuel nozzles 43 are installed through the combustor casing 29. As discussed in greater detail below, the upstream fuel nozzles 43 have a peg design in a preferred embodiment. It will be appreciated that other configurations also are possible.

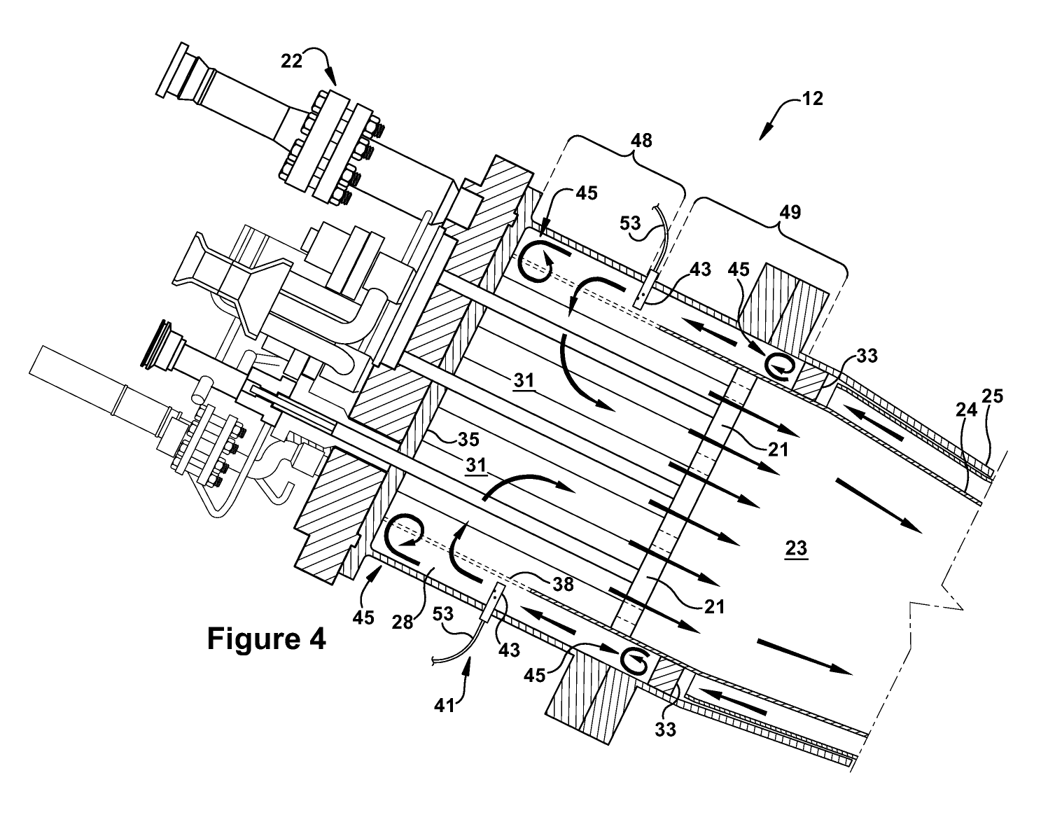

Conventional upstream fuel injection systems are susceptible to instances of flame-holding, which, as mentioned, refers to the phenomena of unexpected flame occurrence at or near the upstream fuel injectors 43. Flame-holding of this type can lead to severe damage to the combustor 12. Occurrences of flame-holding increase as fuel residence time increases in this upstream area of the combustor 12. As indicated in FIG. 4, this region within the combustor 12 typically has several turbulent zones in which flow recirculates in a small area before drawn back into the downstream flowpath. This is due in part by the geometry of the region, which necessarily includes sharp changes in the flow direction, but also is caused by structure that obstructs or abruptly interrupts the flowpath coupled with the velocity and the turbulent nature of the flow. As used herein, this area of recirculation will be referred to as recirculation zones 45, and FIG. 7 indicates several typical areas where these occur.

Recirculation zones 45 are areas of turbulent flow in which at least a portion of the air flow is interrupted and/or recirculates briefly instead continuing in a downstream direction. It will be appreciated that the result of such recirculation is to delay a portion of the flow, which thereby may increase the residence time of fuel released upstream in that particular area of the combustor 12. This increased residence time typically increases the likelihood of flame-holding occurrences. As illustrated, recirculation zones 45 may occur downstream of structure that blocks or interrupts the flow annulus 28 or a portion thereof. As used herein, this type of structure will be referred to as “annulus interrupting structure 33”, and may include, for example, struts, crossfire tubes, igniters, or other conduits. As further illustrated, recirculation zones 45 typically occur near the location at which the end cover 35 terminates the flow annulus 28 and directs the air flow from the flow annulus 28 into the cap assembly 31. It will be appreciated that within this region, the air flow is turned approximately 180° so that it is directed toward the primary fuel injector 21, which results in turbulence and recirculation.

As such, in a typical combustor 12 arrangement, the stretch of flow annulus 28 defined between the cap assembly 31 and the combustor casing 29 includes recirculation zones 45 at each end: at a forward end there is a recirculation zone 45 caused by the redirection of the flow by the end cover 35; and at an aft end, there is a recirculation zone 45 resulting from annulus interrupting structures 33 that are typically located within this area of the combustor 12. Conventional designs do not take into account these recirculation zones 45 and, thereby, unnecessarily increase the likelihood of flame-holding occurrences. According to embodiments of the present invention, the upstream fuel nozzles 43 are positioned within the flow annulus 28 such that a minimum axial offset from both the end cover 35 and the annulus interrupting structure 33 is maintained. In this manner, the likelihood of fuel entering one of these recirculation zones 45 is reduced. The minimum axial offset may relate to the size of the recirculation zone 45 that is expected at each of these locations given a certain mode of engine operation. In other embodiments, each upstream fuel nozzle 43 is positioned approximately midway between the end cover 35 and the annulus interrupting structure 33.

According to other embodiments of the present invention, the upstream fuel nozzles 43 are circumferentially offset from annulus interrupting structures 33. Specifically, as illustrated in FIG. 6, the combustor 12 may be configured such that the groupings of upstream fuel nozzles 43 are circumferentially offset from nearby annulus interrupting structures 33. In such cases, the annulus interrupting structures 33 may be positioned in the wider circumferential spacing that occurs between groupings of upstream fuel nozzles 43. In this manner, the likelihood of injected fuel being recirculated in one of these recirculation zones 45 may be reduced, which, in turn, will also reduce the occurrences of flame-holding that results from the longer fuel residence times caused by the recirculation.

As used herein, the cap assembly 31 and the combustion chamber 23 defined by the liner 24 may be referred to, respectively, as a first interior chamber and a second interior chamber. Additionally, as previously stated, the concentrically arranged cylindrical walls which form the flow annulus 28 may be referred to herein as having an “inner radial wall” and an “outer radial wall”. According to embodiments of the present invention, the upstream fuel nozzles 43 may be circumferentially arrayed on a common injection plane. The common injection plane may be aligned approximately perpendicular relative to a longitudinal axis of the first and second interior chambers of the combustor 12 (i.e., the interior chamber defined by the cap assembly 31 and liner 24). In certain embodiments, the present invention may include between 10 and 20 upstream fuel nozzles 43.

As illustrated in FIGS. 7 and 8, the present invention further includes embodiments describing characteristics of the upstream fuel nozzles 43 and the manner in which these nozzles are configured to optimize the injection of fuel into the flow of compressed air. In one preferred embodiment, the upstream fuel nozzle 43 has a peg design. Specifically, as illustrated in FIG. 7, the upstream fuel nozzle 43 includes a peg-like structure that juts into the flow annulus 28 from the outer radial wall. As illustrated in FIG. 8, the peg may have a circular (or, in other cases, elliptical) cross-sectional profile in which an interior conduit transports fuel from a fuel supply 53 to one or more fuel outlets 44 positioned within the flow annulus 28. These outlets 44 may be placed at varying radial heights within the flow annulus 28 so that greater mixing between fuel and air is achieved.

In accordance with other embodiments of the present invention, the fuel outlets 44 have a varying release direction. It will be appreciated that this aspect further promotes enhanced fuel/air mixing. In such cases, each of the fuel outlets 44 may be described as having release direction relative to a reference direction. For the purposes of defining this direction, the reference direction is the anticipated general flow direction through the flow annulus 20, which, specifically, is assumed herein to be a linear axially oriented flow in the downstream direction. Accordingly, as shown in FIG. 8, the fuel outlet 44 that is oriented in the same direction as the reference direction (i.e., the direction of anticipated flow through the flow annulus 28 as indicated by arrow 51) is described as having a 0° release direction. Similarly, the fuel outlets 44 that are canted 45° to the reference direction are described as having release directions of +/−45°, and the fuel outlets 44 that are oriented perpendicular to the reference direction are described as having release directions of +/−90°. According to preferred embodiments of the present invention, the fuel outlets 44 on each of the pegs are canted between +/−135° relative to the reference direction. In other embodiments, the fuel outlets 44 are canted between +/−90° relative to the reference direction. And, in still other embodiments, a cant of the fuel outlets 44 on each peg is between −135° and −45° and +45° and +135°. These configurations promote enhanced fuel/air mixing.

As one of ordinary skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, all of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof

We claim:

1. A gas turbine engine having a compressor, a combustor, and a turbine, wherein the combustor includes:
an inner radial wall defining a first interior chamber and a second interior chamber, wherein the first interior chamber extends axially from an end cover to a primary fuel injector, and the second interior chamber extends axially from the primary fuel injector to the turbine;
an outer radial wall formed about the inner radial wall so that a flow annulus is formed therebetween;
upstream fuel nozzles jutting into the flow annulus from the outer radial wall;
wherein the upstream fuel nozzles comprise a non-uniform circumferential spacing about the inner radial wall.

2. The gas turbine engine according to claim 1, wherein the non-uniform circumferential spacing corresponds to an angular placement of fuel nozzles within the primary fuel injector.

3. The gas turbine engine according to claim 2, wherein the inner radial wall formed about the first interior chamber comprises a cap assembly and the inner radial wall formed about the second interior chamber comprises a liner;
wherein the outer radial wall formed about the cap assembly comprises a casing and the outer radial wall formed about the liner comprises a flow sleeve, the flow sleeve comprising a plurality of impingement ports through which a region exterior to the outer radial wall fluidly communicates with the flow annulus.

4. The gas turbine engine according to claim 3, wherein the cap assembly includes inlets through which the flow annulus fluidly communicates with the first interior chamber;
wherein the combustor defines a flowpath by which the region exterior to the outer radial wall fluidly communicates with the turbine, the flowpath being configured from an upstream position to a downstream position to include: the impingement ports; the flow annulus; the inlet; the first interior chamber; the primary fuel injector; and the second interior chamber.

5. The gas turbine engine according to claim 4, wherein the combustor comprises a can combustor; and
wherein the inner radial wall and the outer radial wall comprise a concentric cylindrical configuration.

6. The gas turbine engine according to claim 4, wherein the upstream fuel nozzles comprise an upstream location relative to the primary fuel injector, each of the upstream fuel nozzles including a fuel conduit formed through the outer radial wall;
wherein the upstream fuel nozzles are circumferentially arrayed on a common injection plane, the common injection plane having a perpendicular alignment relative to a longitudinal axis of first interior chamber; and
wherein the upstream fuel nozzles include between six and twenty fuel nozzles.

7. The gas turbine engine according to claim 4, wherein the primary fuel injector includes a plurality of periphery fuel nozzles that are spaced about a periphery of the first interior chamber.

8. The gas turbine engine according to claim 7, wherein the primary fuel injector includes a center fuel nozzle; and
wherein the periphery fuel nozzles are spaced about a circumference of the center fuel nozzle.

9. The gas turbine engine according to claim 7, wherein each of the periphery fuel nozzles comprises a reference line that marks an angular position within the first interior chamber;
wherein an outward extension of each of the reference lines marks an angular position on the outer radial wall; and
wherein the non-uniform circumferential spacing of the upstream fuel nozzles comprises one in which the upstream fuel nozzles are grouped about the angular position marked on the outer radial wall by the reference lines so that a grouping of the upstream fuel nozzles coincides with each of the periphery fuel nozzles.

10. The gas turbine engine according to claim 9, wherein the reference line of each of the periphery fuel nozzles is defined by two points: a center of the first interior chamber, and a point at which the periphery fuel nozzle draws closest to the inner radial wall;
wherein the non-uniform circumferential spacing of the upstream fuel nozzles comprises one in which a distance between the upstream fuel nozzles within each grouping is less than the distance between each of the groupings;
wherein the primary fuel injector includes between 4 and 6 periphery fuel nozzles; and
wherein each of the periphery fuel nozzles includes a grouping of between 2 and 5 of the upstream fuel nozzles.

11. The gas turbine engine according to claim 9, wherein the combustor includes annulus interrupting structures that extend between the outer radial wall to the inner radial wall;
wherein the annulus interrupting structures are positioned at circumferentially spaced intervals about the flow annulus;
wherein the annulus interrupting structures are positioned between the groupings of upstream fuel nozzles; and
wherein the annulus interrupting structures comprise struts.

12. The gas turbine engine according to claim 4, wherein the combustor includes annulus interrupting structures that connect the outer radial wall to the inner radial wall;
wherein the annulus interrupting structures are positioned at circumferentially spaced intervals about the flow annulus; and
wherein the upstream fuel nozzles are circumferentially offset from the annulus interrupting structure.

13. The gas turbine engine according to claim 4, wherein the flow annulus occurring between the cap assembly and the casing is defined, at a forward end, by the end cover and, at an aft end, annulus interrupting structures that extend between the outer radial wall and the inner radial wall;
wherein the upstream fuel nozzles are positioned within the flow annulus defined between the cap assembly and the casing; and
wherein each of the upstream fuel nozzles comprises a minimum axial offset from both the end cover and the annulus interrupting structures.

14. The gas turbine engine according to claim 13, wherein each of the upstream fuel nozzles is positioned approximately midway between the end cover and the annulus interrupting structures.

15. The gas turbine engine according to claim 13, wherein the minimum axial offset is greater than an expected recirculation zone at the end cover and an expected recirculation zone downstream of the annulus interrupting structure.

16. The gas turbine engine according to claim 4, wherein each upstream fuel nozzle comprises a peg having a circular or elliptical cross-sectional profile; and
wherein each peg includes a plurality of fuel outlets.

17. The gas turbine engine according to claim 16, wherein each peg includes fuel outlets positioned at varying radial heights within the flow annulus; and
wherein the plurality of the fuel outlets for each of the pegs comprise a release direction that is canted relative to a reference direction that is an anticipated flow direction through the flow annulus, the cant being between −135° and +135°.

18. The gas turbine engine according to claim 16, wherein the plurality of the fuel outlets for each of the pegs comprise a release direction that is canted relative to a reference direction that is an anticipated flow direction through the flow annulus, the cant being between −90° and +90°.

19. The gas turbine engine according to claim 16, wherein the plurality of the fuel outlets for each of the pegs comprise a release direction that is canted relative to a reference direction that is an anticipated flow direction through the flow annulus, the cant is between −135° and −45° and +45° and +135°.

20. An upstream fuel injection system within a gas turbine engine having a can combustor includes an inner radial wall defining a first interior chamber and a second interior chamber, wherein the first interior chamber extends axially from an end cover to a primary fuel injector, and the second interior chamber extends axially from the primary fuel injector to the turbine, wherein an outer radial wall formed about the inner radial wall so that a flow annulus is defined therebetween, wherein the primary fuel injector includes a center fuel nozzle and a plurality of periphery fuel nozzles are spaced about a circumference of the center fuel nozzle, and wherein the can combustor includes annulus interrupting structures that extend between the outer radial wall to the inner radial wall, the upstream fuel injection system comprising:
upstream fuel nozzles jutting into the flow annulus from the outer radial wall;
wherein the upstream fuel nozzles are circumferentially spaced about the inner radial wall so to form a circumferential cluster about an angular position of each of the plurality of periphery fuel nozzles of the primary fuel injector; and
wherein each of the circumferential clusters is circumferentially offset from the annulus interrupting structures.
